(19) United States
(12) Patent Application Publication
(10) Pub. No.: US 2026/0022212 A1
(43) Pub. Date: Jan. 22, 2026

(54) METHODS AND COMPOSITIONS FOR THE INSTANT HYDRATON OF POLYACRYLAMIDE ARTICLES

(71) Applicant: SOLENIS TECHNOLOGIES, L.P., Wilmington, DE (US)

(72) Inventors: Zhaoqing Liu, Newark, DE (US); Yanrong Lu, Newark, DE (US)

(73) Assignee: SOLENIS TECHNOLOGIES, L.P., Wilmington, DE (US)

(21) Appl. No.: 19/264,963

(22) Filed: Jul. 10, 2025

Related U.S. Application Data
(60) Provisional application No. 63/672,759, filed on Jul. 18, 2024.

(51) Int. Cl. C08J 3/05; B29C 71/00; B29K 77/00; B29K 105/00; C08J 3/14; C08J 3/20; C08J 3/205; C08J 3/215; C08J 7/02; C08K 3/16

(52) U.S. Cl. CPC C08J 3/05; B29C 71/0009; C08J 3/14; C08J 3/203; C08J 3/2053; C08J 3/215; C08J 7/02; C08K 3/16; B29K 2077/00; B29K 2105/251; C08J 2333/26; C08K 2003/162

(57) ABSTRACT

Provided are methods and compositions for the instant hydration of polyacrylamide articles. More particularly, a polyacrylamide powder is combined with a binding agent thereby resulting in a particulate composition that is instantly hydrated upon contact with an aqueous solvent. Also provided is a method of producing a polyacrylamide article from the particulate composition. The article is formed when the particulate composition cooled to form a cooled particulate composition. The cooled particulate composition can be dried, pressed, and/or molded. The article, when contacted with an aqueous solvent, quickly disintegrates or dissociates into individual particles, which dissolves into a homogenous solution.

### CROSS-REFERENCE TO RELATED APPLICATIONS

This application claims the benefit of U.S. Provisional Patent Application No. 63/672,759, filed 18 Jul. 2024, the entire contents of which are hereby incorporated by reference.

### TECHNICAL FIELD

The present disclosure generally relates to compositions and methods for the instant hydration of polyacrylamide articles when brought into contact with an aqueous solvent. More particularly, the polyacrylamide article is formed from a particulate composition that is formed when a polyacrylamide powder is combined with a binding agent. The particulate composition comprises coated polyacrylamide particles, particle agglomerates of polyacrylamide particles or granules, or a liquid polyacrylamide suspension. The particulate composition when dispersed into an aqueous solvent instantly hydrates upon contact with the solvent.

The particulate composition can also be cooled and/or dried and/or pressed into a solid polyacrylamide article. The article is in the form of coated polyacrylamide particles, particle agglomerates or granules, or a solid of any shape and size bigger than the granules. The formed article instantly starts to disperse and/or disintegrate as separated particles from the particulate composition when contacted with an aqueous solvent and the individual particles quickly dissolve into a homogenous solution without forming gel aggregates.

### BACKGROUND

Products of polyacrylamide, a polymer generally comprising acrylamide units, are produced in solid, beads, aqueous solution, aqueous dispersion, and inverse emulsion. The aqueous solution or dispersion is limited to low active and/or products of low molecular weight. The water-in-oil inverse emulsion could achieve actives as high as 45% and highest molecular weight among any other processes described above. The inverse emulsion utilizes volatile organic compound (VOC) solvents and organic emulsifiers and surfactants, which are not favorable for the environment.

Although polyacrylamide micro-beads are solid and highly active, the process efficiency is lower, and the polymerization reaction takes place at about 20% active monomer/polymer in a VOC solvent which has to be purified and recycled. The solid obtained by gel polymerization is considered the most sustainable process of choice. The high active products, usually at 30 to 40% active monomer/polymer, are produced in an aqueous gel form, ground, and dried. Gel process could produce anionic polyacrylamide with molecular weight comparable with that from inverse emulsion or even higher than that from inverse emulsion when simultaneous and/or post hydrolysis is implemented in the gel process. However, hydration of rough ground powder. usually having particle size distributions of about 500 μm to about 2000 μm, takes tens of minutes up to hours to complete, depending on the nature of the polymer composition. The long hydration time not only requires energy to mix and space to operate on-site, but also limits its use in applications such as oil fields, which require fast and high-volume input of the polymer aqueous solution. Therefore, short hydration times are needed for almost all of its uses to save time, energy, space, and capital cost of equipment.

Traditionally, fine grinding to less than 300 μm to produce powder of narrower particle size distribution has been used for short hydration times of less than 30 minutes with specially designed make-down equipment to avoid agglomeration or “fish-eyes” formation. As an alternative to avoid agglomeration, the fine powder can also be suspended or dispersed with or without a wetting surfactant(s) or/and suspending agent(s) in an organic solvent and then hydrated. Even though aqueous suspension formulations were successfully commercialized, large amounts of organic quaternary ammonium compound were utilized. The use of organic solvent or quaternary amines increases the cost and environmental impact. On the other hand, fine powder has dust issues and elimination of dust during process, transportation and use of the products could reduce the loss of products, protect the health and safety of the workers and the environment.

Commercially, specially designed make-down equipment is used to disperse the powder under high shear through so-called PSU or polymer slicing unit. As an alternative, the fine powder can also be dispersed in an organic or aqueous solvent containing large amounts of quaternary ammonium and then hydrated under high shear where organic solvents or compounds are used to make polyacrylamide powder slurry suspension or dispersions before the product could be properly dispersed into water under shear. The high shear delivery of the powder or its suspension/dispersion not only consumes energy, but also decreases the polymer molecular weight due to the mechanical action, thus reducing the performance of the polymer which is associated with its high molecular weight. Therefore, what is still needed is a product which does not need high shear for dissolution in water or the use of solvent or expensive organic compounds to aim the dispersion of the polymer particles from the viewpoint of cost and sustainability development.

Other techniques utilize foams to generate porous polyacrylamide granules, which was claimed to have shortened the gel drying time and the powder dissolution time, but only marginally. Still other processes to make fast hydrating polyacrylamide include introducing a cross-linked hydrophilic polymer, such as carboxymethyl starch, to a polyacrylic acid superabsorbent. These so-called disintegrants, which are generally added during polymerization or to the wet gel, only marginally shorten the hydration time. Therefore, shorter hydration of polyacrylamides is still needed for some of the currently used applications.

Also needed is a product which eliminates the fine-powder dust, does not need high shear for dissolution in water or the use of solvent or other organic compounds to aim the dispersion of the polymer particles from the viewpoint of cost and sustainability development.

Accordingly, it is desirable to provide compositions and methods that allow for shorter hydration times of polyacrylamides without the drawbacks mentioned above. Furthermore, other desirable features and characteristics of the present disclosure will become apparent from the subsequent detailed description and the appended claims, taken in conjunction with the accompanying drawings and this background.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is a method of forming a polyacrylamide solution, said method comprising: providing a polyacrylamide powder comprising particles having an average particle size (D₉₀) by volume of less than about 500 μm, or less than 1000 μm, or less than about 1500 μm, providing a binding agent chosen from alkali earth halides, nitrates, their hydrates and combinations thereof; mixing the polyacrylamide powder and the binding agent to form a particulate composition comprising coated polyacrylamide particles, agglomerated particles or granules, or a liquid suspension having a solids content of from about 30 wt. % to about 99.8 wt. %. The particulate composition will have an average particle size (D90) by volume, greater than the average particle size of the particles of the polyacrylamide powder. The binding agent can be mixed with the polyacrylamide powder and liquified or the binding agent can be liquified prior to mixing with the polyacrylamide powder to form the particulate composition. The particulate composition can then be added to an aqueous solvent wherein the coated polyacrylamide particles, agglomerates or granules, or particles in the liquid suspension disassociate and dissolve to form a homogeneous polyacrylamide mixture or solution.

Also provided is a method of producing a polyacrylamide article comprising: providing a polyacrylamide powder comprising particles having an average particle size (D₉₀) by volume of less than about 500 μm, or less than 1000 μm, or less than about 1500 μm, providing a binding agent chosen from alkali earth halides, nitrates, their hydrates and combinations thereof; mixing the polyacrylamide powder and the binding agent to form a particulate composition comprising coated polyacrylamide particles, agglomerated particles or granules, or a liquid suspension having a solids content of from about 30 wt. % to about 99.8 wt. %. The particulate composition is then cooled thus forming a solid particulate composition. The particulate composition can also be pressed, molded, then cooled and/or dried to form the polyacrylamide article. The polyacrylamide article can then be added or combined with an aqueous solvent, wherein the article will disassociate and dissolve to form a homogenous polyacrylamide solution.

Also, provided is a method of producing a polyacrylamide article comprising a particulate composition comprising coated polyacrylamide particles, agglomerated particles or granules, or a liquid polyacrylamide suspension having solids of from about 30 wt. % to about 99.8 wt. %. The coated particles or particles in suspension may be marginally bigger than the powder particles due to the coating or slight swelling.

When the particulate composition is cooled, dried, pressed, and/or molded, a solid polyacrylamide article is formed in the form of coated particulates, granules or solid blocks of any shape and size bigger than the agglomerated particles or granules.

Finally, provided is a polyacrylamide article comprising a particulate composition in the form of coated polyacrylamide particles, agglomerates of particles or granules, or polyacrylamide particles in a liquid suspension. The particulate composition is cooled thus forming a solid polyacrylamide article in the form of coated polyacrylamide particles, agglomerates or granules of the polyacrylamide powder, which can be of uniform size and shape or irregular sizes and shapes, as well as solid forms of any shape and size bigger than the granules, thus forming the article. The article can be used of the polyacrylamide article as described above, in industrial processes such as water-treatment processes, mining processes, petroleum exploration, and recovery processes.

### BRIEF DESCRIPTION OF THE DRAWINGS

The present disclosure will hereinafter be described in conjunction with the following drawing figures, wherein like numerals denote like elements, and wherein:

FIG. 1, is a graph depicting the controlled release of polymer from solid ball(s) with tap water.

FIG. 2, is a graph depicting the controlled release of polymer from solid ball(s) with tap water.

FIG. 3, is a graph depicting the hydration of solid articles from directly grinding of solid polyacrylamide and the binding agent.

FIG. 4, is a graph depicting the hydration of dry polyacrylamide granules from calcium nitrate as the binding agent.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Furthermore, there is no intention to be bound by any expressed or implied theory presented in the preceding technical field, background, brief summary or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

Provided is a method of forming a polyacrylamide solution, said method comprising: providing a polyacrylamide powder comprising particles having an average particle size (D90) by volume of less than about 500 μm, or less than 1000 μm, or less than about 1500 μm, providing a binding agent chosen from alkali earth halides, nitrates, their hydrates and combinations thereof; mixing the polyacrylamide powder and the binding agent to form a particulate composition comprising coated polyacrylamide particles, agglomerated particles or granules, or a liquid suspension having a solids content of from about 30 wt. % to about 99.8 wt. %. The particulate composition has an average particle size (D₉₀) by volume, greater than the average particle size of the particles of the polyacrylamide powder.

The binding agent can be mixed with the polyacrylamide powder and liquified or the binding agent can be liquified prior to mixing with the polyacrylamide powder to form the particulate composition. The particulate composition can then be added to an aqueous solvent wherein the particulate composition will disassociate and dissolve to form a homogenous polyacrylamide solution. The particulate composition dissolves without gel agglomerates or “fisheyes,” which adversely forms from the wetted powder particles when mixed with an aqueous solvent.

In some aspects of the method, the solid binding agent can be liquified by dissolving the binding agent in water, heating the hydrates of the alkali earth halides and/or nitrates to their melting points; or mixing the alkali earth halides, nitrates, and hydrates thereof, with a melting point depressant, and combinations thereof.

In some aspects of the method, the solid binding agent and the polyacrylamide powder are mixed prior to liquifying the solid binding agent.

In other aspects of the method, the solid binding agent can be liquified by heating or by adding a melting point depressant in the form of an inorganic salt other than the binding agent itself, such as NaCl, KCl, CaCl₂, MgCl₂, CaBr₂, MgBr₂, etc. or in the form of organic compounds such as organic amine salts of tetramethylammonium chloride, choline chloride, aminoethanol hydrochloride, N,N-dimethylaminoethanol hydrochloride, glycerol, ethylene glycol, propylene glycol, methanol, ethanol or any other organic and inorganic compounds suitable to lower the melting points.

In some aspects of the method, the hydrates of the solid binding agent have a melting point of from about 5° C. to about 90° C., or from about 30° C. to about 60° C., or from about 35° C. to about 50° C.

In some aspects of the method, the binding agent is chosen from magnesium chloride, magnesium bromide, calcium chloride, calcium bromide, calcium nitrate, magnesium nitrate, zinc nitrate and their hydrates, and combinations thereof.

In some aspects of the method, the binding agent comprises hydrate chosen from calcium chloride hexahydrate, calcium chloride tetrahydrates, magnesium chloride hexahydrate, calcium nitrate hexahydrate, calcium nitrate dihydrate, zinc nitrate hexahydrate, zinc nitrate 2-4 hydrate, calcium bromide hexahydrate, calcium bromide tetrahydrate, calcium bromide dihydrate, magnesium nitrate hexahydrate, calcium nitrate tetrahydrate, calcium chloride dihydrates, and combinations thereof.

In some aspects of the method, the binding agent has a solids content greater than 30 wt. %.

In some aspects of the method, the particulate composition dissolves in water forming a homogenous solution at room temperature in less than about 600 seconds, or less than about 300seconds, or less than about 60 seconds, or less than about 30 seconds. The dissolution time could be obtained when the viscosity of the solution reaches a plateau and/or the heterogeneous mixture turns into a homogeneous one.

In some aspects of the method, further comprising a step of adding processing and functional additives chosen from surfactants, corrosion inhibitors, scale inhibitors, biocides, free-flowing or anti-caking agents, frac sands, other water-soluble polymer particles, effervescent agents and combinations thereof; wherein the processing and functional additives can be combined with the polyacrylamide powder, the solid or liquid additive, or a combination thereof.

Also provided, is a method of producing a polyacrylamide article comprising coated polyacrylamide particles, agglomerated polyacrylamide particles or granules, or polyacrylamide particles in a liquid suspension. The method includes providing a polyacrylamide powder comprising particles having an average particle size (D₉₀) of less than about 500 μm, or less than about 1000 μm, or less than about 1500 μm, and a binding agent chosen from alkali earth halides, nitrates, their hydrates, and combinations thereof. The binding agent can be in a solid form or a liquified form when mixing with the polyacrylamide powder. If the binding agent is in a solid form, the polyacrylamide powder and the binding agent are mixed and the mixture is heated and/or a melting point depressant(s) is added to the mixture and mixed until the binding agent liquifies thereby producing a particulate composition in the form of coated polyacrylamide particles, agglomerated polyacrylamide particles or granules, or a liquid polyacrylamide suspension having a solids content of from about 30 wt. % to about 99.8 wt. %. The particles of the particulate composition will have an average particle size (D₉₀) by volume, greater than the average particle size of the particles of the original polyacrylamide powder.

In other aspects of the method, the binding agent can be liquified prior to mixing with the polyacrylamide powder. In this case, the polyacrylamide powder is added to the liquified binding agent. Depending on the solids content, the article is formed as coated particles of the polyacrylamide powder, agglomerated polyacrylamide particles or granules, or as a liquid polyacrylamide particle suspension having solids of from about 30 wt. % to about 99.8 wt. %. The agglomerates have a particle size (D₉₀) by volume, greater than the average particle size of the particles of the original polyacrylamide powder.

When the binding agent-coated polyacrylamide particles, agglomerated polyacrylamide particles or granules, or liquid polyacrylamide suspension are combined with an aqueous solvent, the coated particles and the particles in the liquid suspension are well dispersed and the particulate composition disintegrate or dissociates into particles having the size of the original polyacrylamide powder, which then quickly dissolve into a homogenous solution.

In some aspects of the method, the particulate composition is cooled, dried, pressed and/or molded prior to combining with an aqueous solvent, thereby forming a polyacrylamide article. The polyacrylamide article can be in any form, for example, in the form of coated powder particles, granules or a block, a sphere or ball, a tablet of any size and shape greater than granules of typical sizes between 0.2 and 4 mm.

The article can be formed at any ratio of liquified binding agent to the polyacrylamide powder, depending on the finished form of the articles. For example, in the case of binding agent coated polyacrylamide particles, the ratio is very low which could be lower than 1%, or 2%, or 5% based on the mass of the powder. If a liquid suspension is the form of the article, then the ratio is higher, e.g., higher than 50%, 80%, 100% or 200%. As for granules or large solids of any size and shape, any ratio could be applied according to the economics and the application efficiency. The granules or large solid form of articles can be molded or/and pressed in any shape and size before cooling and/or drying.

The articles of coated polyacrylamide particles, the liquid suspension of the particles and granules can be directly added to an aqueous solvent to hydrate. On the other hand, the solid article can be of any shape and size greater than the particulate composition and can be liquified by heating or can be molded into granules (500-2000 microns) upon heating, or ground into granules (500-2000 microns) before the polyacrylamide particles are mixed or added to an aqueous solvent.

In some aspect of the method, the solid can be blasted or etched out by water flow from its surfaces in a controlled manner to free the particles in the particulate composition while they are hydrating according to water temperature, water pressure and flow rate. The solid form of the polyacrylamide article can be of any shape and size greater than granules of the particulate composition and can be in the shape of spherical balls of size greater than about 1 cm, or about 5cm, or about 10 cm, The balls can then be placed in a container with a screen to let only the freed powder particles to pass while blasting or etching with an aqueous solvent. The same solid article can be solidified in a container mold and the powder particles are etched or blasted by aqueous solvent from its surface.

Once coming into contact with the aqueous solvent, the article will begin to disperse, or/and disintegrate or/and dissociate into individual particles having the size of the original polyacrylamide powder, which then dissolves into a homogenous solution without forming wet agglomerates.

In some aspects of the method, prior to contacting the polyacrylamide article to an aqueous solvent, an additional step of heating the polyacrylamide article to a melting point of the solid binding agent, thereby liquifying the binding agent and releasing the particles of the polyacrylamide article back into the original particles of the polyacrylamide powder having an average particle size (D₉₀) of less than about 500 μm, or less than 1000 μm, or less than about 1500 μm.

In some aspects of the method, a liquid suspension is formed using a suspending or stabilizing agent, such as clay or modified clay, by using melting point depressants, such as inorganic salts other than the binding agent itself. For example, the melting point depressant can be an inorganic salt, such as NaCl, KCl, CaCl₂, MgCl₂, CaBr₂, MgBr₂, etc. The melting point depressant can be in the form of organic compounds such as organic amine salts of tetramethylammonium chloride, choline chloride of less than 5% by weight according to the total mass of the suspension, monoethanolamine hydrochloride, N,N-dimethylaminoethanol hydrochloride, glycerol, ethylene glycol, propylene glycol, methanol, ethanol or any other organic and inorganic compounds suitable to lower the melting points. The stabilized liquid suspension is combined with an aqueous solvent to be hydrated.

In some aspects of the method, the particles of the polyacrylamide article are released by directing a flow of water over a surface or surfaces of the article, using techniques such as blasting or etching. The released particles have an average particle size (D₉₀) of less than about 500 μm, or less than 1000 μm, or less than about 1500 μm.

In yet other aspects, the polyacrylamide article can be used in processes and applications, such as, in water-treatment processes, mining processes, agriculture and soil management, industrial production processes, petroleum exploration, and recovery processes.

### EXAMPLES

### Example #1

25.11 grams (g) of Praestol™ 2530 powder (a copolymer of acrylic acid and acrylamide, sodium salt from Solenis) having an average particle size of 143 μm (D90 by light scattering), was suspended in a warm solution of 24.6 grams calcium chloride dihydrate in 10.0 grams water. The suspension was then quickly cooled in a plastic tube to form inside the tube as a solid block. The particles in the solid block were then dispersed with jetted water from the open surface as swelling particles suspension in water, which then dissolved into a homogenous solution within a few minutes with moderate mixing. No aggregates were observed. The solid block can be heated and then turned back into a pourable liquid suspension which is added to water. The powder particles are easily dispersed and then dissolved in water.

### Example #2

30.03 grams of Praestol™ 2530 powder (copolymer of acrylic acid and acrylamide, sodium salt from Solenis) having an average particle size of 143 μm (D90 by light scattering), was suspended in a warm solution of 19.91 grams calcium chloride dihydrate in 10.1 grams of water. The suspension was then cooled in a plastic tube to form a solid block. The particles of the solid block were then dispersed with jetted water swelling the particles in suspension, which then dissolved into a homogenous solution within a few minutes with moderate mixing. No aggregates were observed. The same solid block can be recovered as a flowable liquid suspension upon heating and easily dispersed in water in the same way as Example #1.

### Example #3

20.11 grams Praestol™ 2530 powder (copolymer of acrylic acid and acrylamide, sodium salt from Solenis), and having an average particle size of 143 μm (D90 by light scattering), was suspended in a warm solution of 16.26 grams calcium chloride dihydrate in 10.7 grams water. The suspension was then cooled in a plastic tube to form a solid block. The particles of the solid block were then dispersed with jetted water swelling the particles in suspension, which then dissolved into a homogenous solution within a few minutes with moderate mixing. No aggregates were observed. The same solid block can be recovered as a flowable liquid suspension upon heating and easily dispersed in water in the same manner as Example #1.

### Example 4-9

The same procedure as used in Examples 1 to 3, was used in Examples 4-9, except different commercial anionic polymers were used. A liquified binding agent was prepared from anhydrous calcium chloride. Examples 5, 6, 8 and 9, use co-polymers of acrylamide and acrylic acid, sodium salt. Examples 4 and 7, are terpolymers of acrylamide, acrylic acid and 2-acrylamido-2-methyl-1-propanesulfonic acid, sodium salt. The particles of the solid block were then dispersed with jetted water as swelling the particles in suspension, which then dissolved into a homogenous solution within a few minutes with moderate mixing. No aggregates were observed. The same solid block can be recovered as a flowable liquid suspension upon heating and easily dispersed in water.

TABLE 1
Solid Blocks of Instant Hydrating Polyacrylamide

| | | 5 | 6 | 7 | 8 | 9 |
|---|---|---|---|---|---|---|
| | 4 | NuoerFloc ™ | | | | Praestol ™ |
| Product | Terpolymer | ZR048 | 8105C | 8384B | ZR044 | 2530 |
| CaCl₂ | 9.019 | 9.015 | 9.018 | 9.014 | 9.022 | 9.014 |
| Water | 8.201 | 7.996 | 7.814 | 8.004 | 7.818 | 7.829 |
| Temp. to dissolve, ° C. | 82 | 82 | 82 | 82 | 83.6 | 82 |
| % CaCl₂ in liquid phase | 52.4 | 53.0 | 53.6 | 53.0 | 53.6 | 53.5 |
| Powder Product | 11.851 | 12.015 | 12.029 | 11.528 | 12.015 | 12.013 |
| Powder in temperature ° C. | 67 | 68.4 | 68 | 67.8 | 66.7 | 68.1 |

Finished Solid Block Composition:

| | | | | | | |
|---|---|---|---|---|---|---|
| % CaCl₂ | 31.02 | 31.06 | 31.25 | 31.58 | 31.27 | 31.24 |
| % PAM | 40.77 | 41.39 | 41.68 | 40.38 | 41.64 | 41.63 |
| % Water | 28.21 | 27.55 | 27.07 | 28.04 | 27.09 | 27.13 |

### Example #10

15.582 grams of calcium bromide hydrate, (89.6% solid at 120° C.) was dissolved in 4.146 gram of water by heating the mixture to about 80° C. After dissolution was complete, 14.444 grams of Praestol™ 2530 (D90, 251 μm) was suspended in the CaBr₂ solution. The suspension was immediately cooled to obtain a solid block. Polymer fine particles were able to be blasted out with water and dispersed as swelling particles and then dissolved into a homogenous solution within a few minutes with moderate mixing. No aggregates were observed. The same solid block can be recovered as flowable liquid suspension upon heating and easily dispersed in water.

### Example #11

20 grams of Praestol™ 2530 powder (copolymer of acrylic acid and acrylamide, sodium salt), and having an average particle size of 143 μm (D90 by light scattering), was mixed with 2.01 grams of anhydrous calcium chloride powder and heated to about 60° C. until the mixture turned soft. The mixture was packed in a plastic bag and pressed under 1.6 kg weight with pressure of about 0.17 kg/cm2 until the mixture turned into solid block for storage. The solid block was easily softened and granulated to a particle size of about 1 millimeter (mm) to about 3 mm in size upon reheating to 60° C. The “wet” or dry granules were totally dispersed as fine powder particles and dissolved when added to water. The term “wet” granule is a granule having more water and softer agglomerates that are fragile to handle. After most of the water is removed, the granule becomes harder and stronger, which can be more easily transported.

Example #12

20 grams of Praestol™ 2530 powder (copolymer of acrylic acid and acrylamide, sodium salt), and having an average particle size of 143 μm (D90 by light scattering), was mixed with 5.00 grams of calcium chloride tetrahydrate and heated to about 50° C. until the mixture turned soft. The mixture was packed in a plastic bag and pressed under 1.6 kg weight with a pressure of about 0.17 kg/cm² until the mixture turned into a solid block for storage. The solid block could be easily softened and granulated to about 1 to 3 mm in size upon heating to 60° C. The “wet” or dry granules were able to be totally dispersed as fine powder particles and dissolved when added to water.

Example #13

20 grams of Praestol™ 2530 powder (copolymer of acrylic acid and acrylamide, sodium salt) and having an average particle size of 213 μm (D90 by light scattering), was mixed with 2.00 gram of anhydrous calcium chloride and heated to around 50° C. until the mixture turned soft. The mixture was packed in a plastic bag and pressed under 1.6 kg weight with pressure of about 0.17 kg/cm2 until the mixture turned into a solid block for storage. The solid block was easily softened and granulated to a particle size of about 1 mm to about 3 mm in size upon heat to 60° C. The “wet” or dry granules were found totally disintegrated and dissolved in water.

### Example #14

9 grams Praestol™ 2530 powder (copolymer of acrylic acid and acrylamide, sodium salt) and having an average particle size of 251 μm (D90 by light scattering), and 1 gram of Aqualon™ CMC 7H3SF, comprising sodium carboxymethylcellulose, was mixed with 2.00 grams anhydrous calcium chloride and heated to about 50° C. until the mixture turned soft. The mixture was packed in a plastic bag and pressed under 1.6 kilograms (kg) weight with a pressure of about 0.17 kg/cm², until the mixture turned into a solid block for storage. The solid block was easily softened resulting in granules of from about 1 mm to about 3 mm in size upon heating to 60° C. and totally disintegrated and dissolved in water.

### Example #15

1.03 grams of sodium chloride, 8.94 grams calcium chloride hexahydrate and 0.66 grams of water, were mixed until almost all solids turned into a liquid solution. 1.88 grams of the salt solution was then mixed with 10 grams of Pracstol™ 2530 powder (copolymer of acrylic acid and acrylamide, sodium salt) having an average particle size of 143 μm (D90 by light scattering), producing a granulated powder. The granulated powder at room temperature was pressed through a 16 mesh sieve, and dried by heating the sieved powder to a temperature between 70° C. to 80° C. Either the “wet” or dry granules are stable enough to store and transport. “Wet” granules have more water and are usually soft agglomerates, fragile to be handled. After most of the water is removed, it becomes harder and stronger granules which can be transported over long distance. The granules were found well dispersed upon contact with water, freeing the powder particles and dissolved polymer within about 2 to 3 minutes.

### Example #16

1.00 grams of magnesium chloride hexahydrate and 4 grams calcium chloride hexahydrate were mixed until almost all solids turned into a liquid salt solution. 1.71 grams of the liquid salt solution was mix with 10 grams of Praestol™ 2530 powder (copolymer of acrylic acid and acrylamide, sodium salt), having an average particle size of 251 μm (D90 by light scattering), producing a granulated powder. The granulated powder, at room temperature, was pressed through a 16 mesh sieve and dried at a temperature of from between about 70° C. to about 80° C. Either the “wet” or dry granules were found well dispersed upon contact with water, freeing the powder particles and dissolved polymer within 2-3 minutes.

### Example #17

1.00 gram of calcium bromide hexahydrate and 4 grams of calcium chloride hexahydrate were mixed until almost all solids turned into a liquid salt solution. 1.71 grams of the liquid salt solution was mix with 10 grams of Praestol™ 2530 powder (copolymer of acrylic acid and acrylamide, sodium salt) of particle size of 251 μm (D90 by light scattering), producing a granulated powder. The granulated powder at room temperature was pressed through a 16 mesh sieve and dried at a temperature of between about 70° C. to about 80° C. Either the “wet” or dry granules were found well dispersed upon contact with water, freeing the granulated powder particles, which completely dissolved within about 2 to 3 minutes.

### Example #18

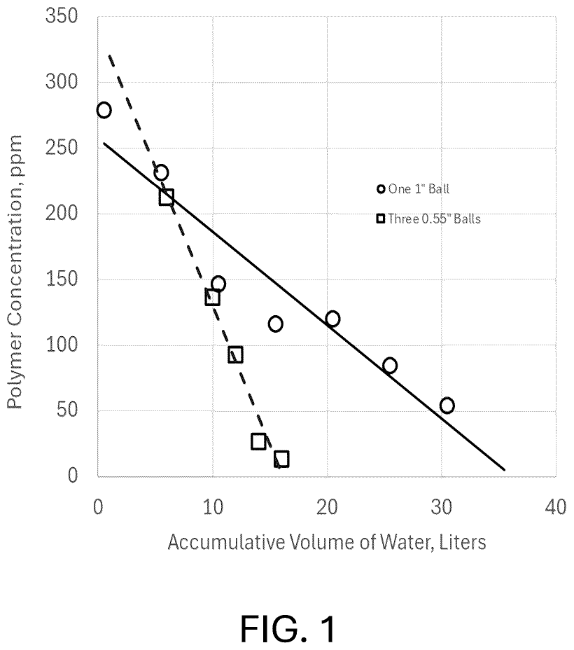

24 grams of Praestol™ 2530 powder (copolymer of acrylic acid and acrylamide, sodium salt) having an average particle size of 143 μm (D90 by light scattering), was added and mixed at a temperature of from about 50° C. to about 60° C. with 24 grams of calcium chloride dihydrate that had been dissolved in 6 grams of water at 90° C., which resulted in a paste. The paste was packed inside a mold having the shape of a one-inch diameter spherical ball. The ball was then cooled in a freezer until solidified. The release of polymer powder from the solid ball was evaluated with running water. Therefore, one such ball in a 100 milliliter (ml) bottle was placed about 1.5 feet below a water-tap. Water was allowed to cascade over the ball and the overflow was screened through 14 mesh screen and sampled for analysis of the viscosity. The content of the polymer dissolved was estimated from the measured viscosity against the standard concentration. No residual gel was observed on the screen and the hard or solid ball was found to be totally washed out gradually and no gel coat was found on the surface of the ball during the process. Fine particles were visible in the overflow water and dissolved within about 2 to 3 minutes. The polymer concentration in ppm of the overflow water was shown in FIG. 1, which confirmed the slow release of powder particles into water in a controllable manner.

### Example #19

Pracstol™ 2530 powder (a copolymer of acrylic acid and acrylamide, sodium salt) of particle size of 143 μm (D90 by light scattering), 54.5 grams was added and mixed at 50-60° C. into 54.5 grams of calcium chloride dihydrate dissolved in 22.7 grams of water at 80° C. The pasted was packed inside a ball mold of 0.55 inch in diameter and cooled in freezer for 15 minutes to solidify and then to stand by at room temperature overnight. These solid balls were found stable without deformation at room temperature with melting point around 30° C. The release of polymer powder from the solid ball was evaluated with running water. Therefore, three balls in a 100 ml bottle were placed about 1.5 feet below a water-tap. Let water flash over the ball and the overflow was screened through 14 mesh screen and sampled for analysis of the viscosity. The content of the polymer dissolved was estimated from the measured viscosity against the standard concentration. No residual gel was observed on the screen and the solid ball was found to be totally washed out gradually and no gel coat on the surface during the process. Fine particles were visible in the overflow water and dissolved within about 2 to about 3 minutes. The polymer concentration of the overflow water was shown in FIG. 1, which confirmed the slow release of powder particles into water in a controllable manner. In comparison, three 0.55″ inch balls released polymer faster than one 1″ ball as described in Example #18.

### Example #20

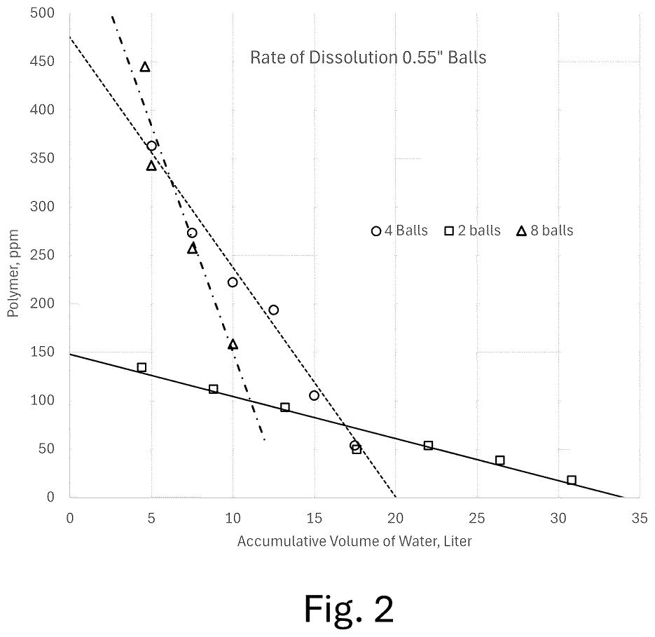

A sample of Praestol™ 2530 powder (a copolymer of acrylic acid and acrylamide, sodium salt) of particle size of 143 μm (D90 by light scattering), 48 grams was first mixed with 14.1 g calcium chloride dihydrate and heated to 50° C. to about 60° C. until the powder turned soft. The softened powder was added and mixed at about 50° C. to about 60° C. into 37.93 grams of 60% calcium chloride solution at about 50° C. to about 60° C. The pasted was packed inside an arrange of ball mold of 0.55-inch in diameter, letting it cool and solidify at room temperature overnight. These solid balls were found stable without deformation at room temperature with melting point of about 35° C. The release of polymer powder from the solid ball was evaluated with running water. Therefore, 2, 4 or 8 balls in a 100 ml bottle were placed about 1.5 feet below a water-tap. Let water flash over the ball and the overflow was screened through 14 mesh screen and sampled for analysis of the viscosity. The content of the polymer dissolved was estimated from the measured viscosity against the standard concentration. No residual gel was observed on the screen and the solid ball was found to be totally washed out gradually and no gel coat on the surface during the process. Fine particles were visible in the overflow water and dissolved within 2-3 minutes. The polymer concentration of the overflow water was shown in FIG. 2, which confirmed the slow release of powder particles into water in a controllable manner. More ball counts achieved high and fast release of the particles and the polymer in water.

### Example #21

1.40 parts of monoethanolamine was neutralized with 2.33 parts of 37% hydrochloric acid. The resulting solution was mixed with 3.45 parts of anhydrous calcium chloride and 2.82 parts of water. The liquified CaCl₂ binder has a melting point of about −10° C. To this liquid, 6.50 parts of NuoerFloc™ 8384B (60 mesh, from Nuoer Chemical) was added, which resulted in a suspension. The suspension was found to be stable from about −10° C. to about 45° C. and easily dispersed into water and dissolved into a homogenous solution.

### Example #22

1.59 parts of N,N-dimethylethanolamine was neutralized with 1.70 parts of 37% hydrochloric acid. The resulting solution was mixed with 3.45 parts of anhydrous calcium chloride and 3.25 parts of water. The liquified CaCl₂ binder has a melting point below −20° C. To this liquid, 6.50 parts of NuoerFloc™ 8384B (60 mesh) added, which resulted in a suspension. The suspension was found stable from about −20° C. to about 45° C. and easily dispersed into water and dissolved into a homogenous solution.

### Supplemental Data:

Polyacrylamide particles were obtained by crushing dry gel particles of 1-5 mm in size to less than 1 mm first with a traditional hammer mill, and then to less than 300 microns for faster hydration. In the following examples, the binders were combined with the polyacrylamide particles during the grinding of the dry polyacrylamide particles. The binder was found to either coats or/and bind the dry gel particles, resulting in particles, which are self-dispersive in water without forming aggregates even under low shear environment.

The following examples show that the polyacrylamide powder particles having an average particle size (D90) of less than about 500 μm, or less than about 1000 μm, or less than about 1500 μm, can be obtained by grinding the polymer solids having an average particle size (D90) greater than about 500 μm, or greater than about 1000 μm, or greater than about 1500 μm in the presence of a binding agent. Therefore, grinding and preparation of the article can be done in a single process. The binding agent can be added before, during or immediately after the grinding. The grinding can be done by attrition, impact or media mill, depending on the relative ratio of the powder to the binding agent. The heat and/or moisture from the grinding process can also be utilized to liquify the solid binding agent.

### Example #23

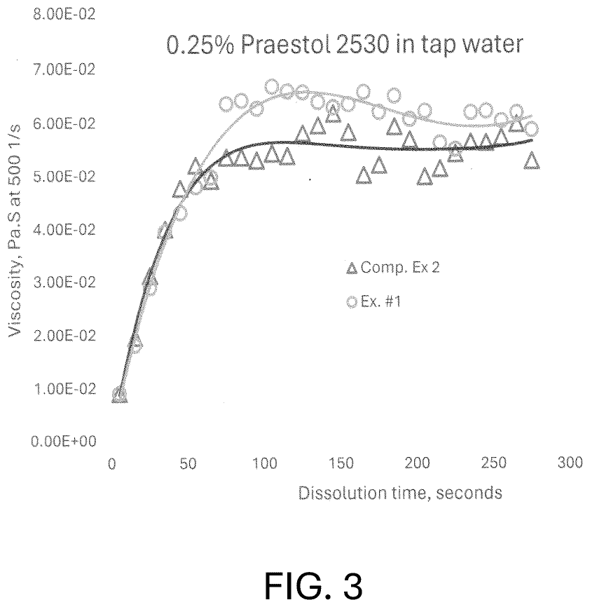

Praestol™ 2530 of particles size of 1 mm, 100 grams, was mixed with 22 grams of anhydrous calcium chloride. The mixture was milled on a Bunn coffee mill as “Espresso”. The size distribution of the product can be seen in Table 2. The ground particles were found easily dispersible in water with minimum agitation. Fine particles of 80-200 mesh were demonstrated to disperse and dissolve without any visible aggregates (0.25 g in 80 ml tap water) at 500 1/s shear rate, reaching viscosity plateau within 2 minutes according to nominal viscosity on a Discovery HR-2 Hybrid Rheometer equipped with a vane probe (FIG. 3).

### Example #24 (Comparative)

Praestol 2530 of particles size of 1 mm, 100 gram was milled without the binder under identical conditions to Ex #23. The results in size distribution and hydration are shown in Table 2 and FIG. 3, respectively. No calcium chloride white coatings were observed on the ground particles. Aggregates were observed when the ground powder was added to water under the same conditions as Example #23. even though the particles size and their distribution are similar to Example #23 (Table 2). Hydration at 0.25% in tap demonstrated aggregates suspended in the solution as well as on the vane probe, resulting in incomplete hydration or/and dissolution of the polymer (FIG. 3).

TABLE 2
Particle Size Distribution of Ground Particles

| | | Ex. #23 | Comp. Ex. |
|---|---|---|---|
| Mesh screen | Size, mm | (% Wt) | #24 (% Wt) |
| >18 | >1 | 0.4 | 0.0 |
| 18-25 | 0.71-1 | 3.7 | 3.7 |
| 25-35 | 0.5-0.71 | 24.2 | 28.5 |
| 35-80 | 0.18-0.5 | 64.3 | 56.3 |
| 80-200 | 0.075-0.18 | 7.3 | 11.0 |
| <200 | <0.075 | 0.1 | 0.6 |

### Example #25

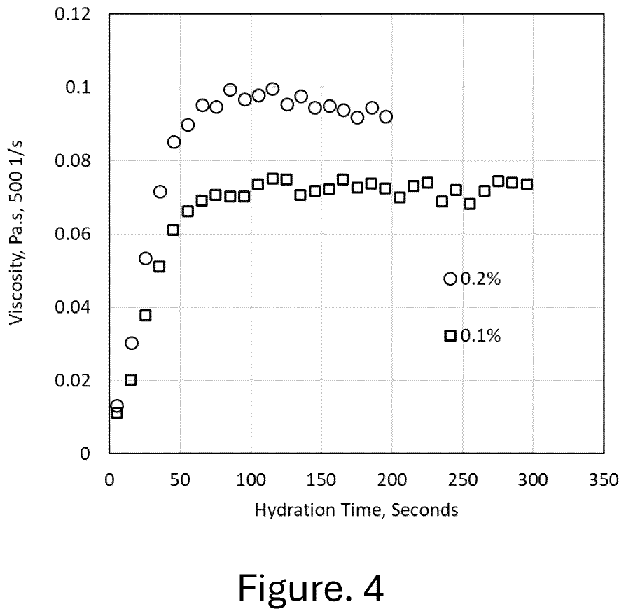

Praestol™ 2530 powder (copolymer of acrylic acid and acrylamide, sodium salt) having an average particle size of 241 μm (D90 by light scattering), 5.6 grams, was mixed with 0.50 gram of calcium nitrate tetrahydrate and heated to around 60-65° C. until the powder was well mixed with the liquified binder. A small sample of the mixture (binder wetted powder/granules) was dispersed into water with manual mixing and the test indicated that no fisheyes were formed and the dispersed particles were dissolved within 2 minutes. The mixture (binder wetted powder/granules) was then dried at 85-90° C. and crashed through 18 mesh sieve to obtain the dry granules. The hydration of the dry granules was monitored in tap water according to the nominal viscosity on a Discovery HR-2 Hybrid Rheometer equipped with a vane at a nominal 500 s-1 shear rate. Complete hydration was observed within 100 seconds (FIG. 4).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

We claim:

1. A method of forming a polyacrylamide solution, said method comprising:
providing a polyacrylamide powder comprising particles having an average particle size (D₉₀) by volume of less than about 500 μm, or less than about 1000 μm, or less than about 1500 μm
providing a binding agent chosen from alkali earth halides, nitrates, their hydrates, and combinations thereof;
mixing the polyacrylamide powder and the binding agent to form a particulate composition comprising coated polyacrylamide particles, agglomerated particles or granules, or a liquid polyacrylamide suspension having a solids content of from about 30 wt. % to about 99.8 wt. %; and
combining the particulate composition with an aqueous solvent, wherein the coated polyacrylamide particles, granules, or particles in the liquid suspension disassociate and dissolve to form the polyacrylamide solution.

2. The method according to claim 1, wherein the binding agent is mixed with the polyacrylamide powder and then liquified.

3. The method according to claim 1, wherein the binding agent is liquified prior to mixing with the polyacrylamide powder.

4. The method according to claim 1, wherein the particulate composition has an average particle size (D₉₀) by volume, greater than the average particle size of the particles of the polyacrylamide powder.

5. The method according to claim 1, further comprising liquifying the binding agent by dissolving the binding agent in water; heating the hydrates of the alkali earth halides and/or nitrates to their melting points; mixing the alkali earth halides, nitrates, and hydrates thereof with a melting point depressant; and combinations thereof.

6. The method according to claim 1, wherein the binding agent is liquified by heating and/or addition of a melting point depressant.

7. The method according to claim 1, wherein the binding agent is mixed with the polyacrylamide particles and the polyacrylamide particles of the mixture is ground to a desired particle size.

8. The method according to claim 1, wherein the binding agent comprises a hydrate, and wherein the hydrate of the binding agent has a melting point of from about 5° C. to about 90° C., or from about 30° C. to about 60° C., or from about 35° C. to about 50° C.

9. The method according to claim 1, wherein the binding agent is chosen from magnesium chloride, magnesium bromide, calcium chloride, calcium bromide, calcium nitrate, magnesium nitrate, zinc nitrate and their hydrates, and combinations thereof.

10. The method according to claim 9, wherein the binding agent comprises a hydrate chosen from calcium chloride hexahydrate, calcium chloride tetrahydrates, magnesium chloride hexahydrate, calcium nitrate hexahydrate, calcium chloride dihydrate, zinc nitrate hexahydrate, zinc nitrate 2-4 hydrate, calcium bromide hexahydrate, calcium bromide tetrahydrate, calcium bromide dihydrate, magnesium nitrate hexahydrate, calcium nitrate tetrahydrate, calcium chloride dihydrates, and combinations thereof.

11. The method according to claim 1, wherein the binding agent has a solids content greater than 30 wt. %.

12. The method according to claim 1, wherein the solids in the polyacrylamide composition dissolve in water into a homogenous solution at room temperature in less than about 600 seconds, or less than about 300 seconds, or less than about 60 seconds, or less than about 30 seconds after combining the particulate composition and the aqueous solvent.

13. The method according to claim 1, further comprising providing processing and functional additives chosen from surfactants, corrosion inhibitors, scale inhibitors, biocides, free-flowing agents, frac sands, effervescent agents, and combinations thereof, wherein the processing and functional additives are combined with the polyacrylamide powder and/or the binding agent.

14. A method of producing a polyacrylamide article comprising:
providing the particulate composition according to claims 1,
cooling the particulate composition to form a cooled particulate composition;
pressing, molding, cooling, and/or drying the particulate composition, prior to combining with an aqueous solvent, thereby forming the polyacrylamide article.

15. The method according to claim 14, wherein the polyacrylamide article is in the form of a block, a sphere, a tablet, a liquid suspension comprising from about 30% to about 99.8% solids, or water-containing polyacrylamide granules having an average particle size (D₉₀) by volume greater than the average particle size of the particles of the polyacrylamide powder.

16. The method according to claim 14, further comprising the step of heating the polyacrylamide article to a melting point of the binding agent, thereby releasing the particles of the polyacrylamide article back into particles having an average particle size (D₉₀) by volume of less than about 500 μm, or less than about 1000 μm, or less than about 1500 μm.

17. The method according to any one of claims 14, wherein the particles of the polyacrylamide article are released back into particles having an average particle size (D₉₀) of less than about 500 μm, or less than about 1000 μm, or less than about 1500 μm by the aqueous solvent to form a homogeneous mixture.

18. The method according to any one of claims 14, wherein the polyacrylamide article disintegrates or dissociates upon contact with water into polyacrylamide particles having an average particle size (D₉₀) of less than about 500 μm, or less than about 1000 μm, or less than about 1500 μm upon contact with the aqueous solvent.

19. Use of the polyacrylamide article according to claim 14, in water-treatment processes, mining processes, agriculture and soil management, industrial production processes, petroleum exploration, and recovery processes.

20. The polyacrylamide article according to claim 14.
